(19) United States
(12) Patent Application Publication
(10) Pub. No.: US 2025/0378008 A1
(43) Pub. Date: Dec. 11, 2025

(54) METHOD FOR LEARNING A STATE MACHINE FOR A PROGRAM

(71) Applicant: Robert Bosch GmbH, Stuttgart (DE)

(72) Inventors: Christopher Huth, Heilbronn (DE); Max Camillo Eisele, Ludwigsburg (DE)

(21) Appl. No.: 19/230,270

(22) Filed: Jun. 6, 2025

(30) Foreign Application Priority Data
Jun. 7, 2024 (DE) 10 2024 205 234.5

(51) Int. Cl. G06F 11/362

(52) U.S. Cl. CPC G06F 11/3636

(57) ABSTRACT

A method for learning a state machine for a program including executing, via a host computer system, a state machine learning algorithm, wherein the host computer system controls an embedded system via a debugging interface by means of a debugger such that it executes the program several times. The host computer system detects for each execution of the program whether a program section has been reached which has not yet been reached during the previous executions of the program; and, when it detects this, an input to the program which was not supplied to the program by the host computer system and which caused the program to reach the program section, by using the debugger to determine a memory area of the embedded system into which the input was written, reading it out, and adding the determined input to an alphabet.

### SUMMARY

The present disclosure relates to methods for learning a state machine for a program executed on an embedded system.

Testing is an essential part of software application development. In particular, errors that lead to failure of an application should be identified and corrected. This is particularly true for embedded system programs.

Embedded systems generally comprise a microcontroller that processes inputs and responds with outputs in order to accomplish a particular task. Although microcontrollers use the same memory model and are programmed with the same programming languages as normal user programs, their programs are much more difficult to test. In order to make debugging possible, microcontrollers generally provide the ability to interrupt the program with breakpoints, run through the program's instructions in individual steps, and set watchpoints (memory observation points) on memory addresses. Watchpoints trigger an interrupt when the corresponding memory areas are accessed. Hardware breakpoints and watchpoints are implemented as physical registers in the debug unit of the microcontroller and their number is therefore limited. Watchpoints can usually distinguish between read access and write access.

From the perspective of the testing system (i.e., the “test computer system”), an embedded system can be a black box. In addition, it may have sensors, etc., that generate data on which the behavior of the embedded system depends but which are not fed to it via its “normal” input interface. Since some errors are state-dependent and very deep, i.e., they occur in states that are only reached after specific long input sequences, reliable approaches for testing programs for embedded systems are desirable.

According to various embodiments, a method for learning a state machine for a program executed on an embedded system is provided, comprising: Executing, by means of a host computer system connected to the embedded system via a debugging interface and via an input data interface, a state machine learning algorithm, wherein the host computer system controls the embedded system via the debugging interface by means of a debugger such that it executes the program several times and, wherein the host computer system
detects for each execution of the program whether, during the execution of the program, a program section has been reached which has not yet been reached during previous executions of the program; and
if it detects that a program section has been reached which has not yet been reached in the previous executions of the program, at least for some of the cases in which a program section has been reached which has not yet been reached in the previous executions of the program,
   determines an input to the program which has not been supplied to the program by the host computer system and which caused the program to reach the program section, by using the debugger to determine a memory area of a memory of the embedded system into which the input was written and reading it out; and
   adds the determined input to an alphabet of the state machine learning algorithm.

The method described above enables debugger-controlled state machine estimation. This does not require instrumentation or emulation, but only a debugging interface between the host computer system (e.g., a test (computer) system) and the target system (which executes the program to be tested) with the ability to set breakpoints and watchpoints. These types of debugging interfaces and capabilities are generic and widely available, resulting in broad and easy applicability of the method.

The method can only be implemented with low memory load on the target system (e.g., for metadata), as the information is collected and stored on the host side of the debugger. In particular, the size of the compiled binary file of the program does not need to be increased, i.e., the program in its executable version can be used unchanged.

Debuggers pause the target system when a breakpoint or watchpoint is reached. Therefore, the above method only rarely leads to time-based false alarms. Such false alarms can also be ruled out by other testing techniques, e.g., by validating a found error on the target system.

The above procedure provides great insight into the internals of the target system because it uses a debugger. It does not require the source code of the program to be available for code instrumentation, nor does it require instruction set-specific (vulnerable) instrumentation based on the binary file (binary instrumentation). Emulator-based instrumentation is also very platform-specific, and each embedded platform requires its own emulator. The debugger-driven approach according to the above method does not rely on complex instrumentation or emulation and is therefore widely applicable. In addition, the target system (e.g., a control device in a vehicle) can operate in productive operation and does not need to be isolated.

The state machine can be used to determine coverage information (of a test, e.g., fuzzing) while it is being learned. Conversely, state transitions discovered during fuzzing can be used to learn the state machine.

The target system can be a device to be tested, a system (consisting of several devices) to be tested, or even a system of systems in which only parts of the state machine of the system are learned according to the above method, wherein not every single device needs to be connected to a debugger.

Various exemplary embodiments are specified in the following.

Exemplary embodiment 1 is the method for learning a state machine as described above.

Exemplary embodiment 2 is the method according to exemplary embodiment 1, wherein the host computer system supplies the (at least one) input that was not supplied by the host computer system to the program and that it has determined (in response to program sections being reached that had not been reached before) to the program by using the debugger in at least some executions of the program.

The host computer system therefore uses (in addition to the inputs via its “normal input (data) interface to the embedded system”) inputs supplied to the program externally (from the perspective of the host computer system) to determine the state machine. This enables complete and correct determination of the state machine in the event of additional data sources for the program (other than the input via the input interface of the embedded system, by means of which the host computer system can supply data to the program, e.g., sensors of the embedded system).

Exemplary embodiment 3 is the method according to exemplary embodiment 2, wherein the host computer system writes the input (or each of at least some of the inputs, if there are several, i.e., several have been determined with which program sections not yet reached have been reached) in at least some executions of the program by using the debugger into the respective determined memory area of the memory of the embedded system.

In this way, the host computer system can simulate the input from an external data source by writing it directly into the memory of the DUT (device under test) using the debugger, where the input would also be written by the external data source.

Exemplary embodiment 4 is the method according to one of exemplary embodiments 1 to 3, wherein the host computer system determines the memory area of the memory of the embedded system in which the input was written by setting watchpoints on different memory areas of the embedded system's memory and, depending on which watchpoint is triggered, identifying the memory area to which the triggered watchpoint was set as the memory area in which the input was written.

This allows the host (computer) system to determine the relevant memory areas for externally controlled inputs without having to look at the internal structure of the program. If, for example, it is able to observe interrupts from external data sources, it can assign the memory area on which a watchpoint has been set (if applicable) to the respective data source. The host system can set the watchpoints differently for multiple executions in order to “search” for the memory areas in memory. The host system can also set the watchpoints specifically to input addresses of conditions if it has identified them (e.g., using the debugger).

Exemplary embodiment 5 is the method according to exemplary embodiment 4, wherein the host computer system determines the memory area of the memory of the embedded system into which the input was written by observing a connection between a data source that supplies the input and comparing it with memory contents of the memory areas of the memory to which the watchpoints were set and which were triggered.

The host system therefore does not need to search the entire memory to identify the memory areas, but can limit itself to those on which it has set watchpoints that have been triggered. Again, if there are multiple executions, the host system can set the watchpoints differently to search the memory for the memory areas to which the inputs from the external data source(s) are written.

Exemplary embodiment 6 is a method for testing a program on an embedded system, comprising: learning a state machine of the program according to one of exemplary embodiments 1 to 5; and testing the program during execution on the embedded system, taking into account the learned state machine.

For example, state-dependent fuzzing can be performed. The state machine can also be further learned during testing (or testing and learning of the state machine can be performed in parallel from the outset).

Exemplary embodiment 7 is a computer system configured to perform a method according to one of exemplary embodiments 1 to 6.

Exemplary embodiment 8 is a computer program with commands that, when executed by a processor, cause the processor to carry out a method according to any of exemplary embodiments 1 to 6.

Exemplary embodiment 9 is a computer-readable medium that stores commands that, when executed by a processor, cause the processor to perform a method according to any of exemplary embodiments 1 to 6.

### BRIEF DESCRIPTION OF THE DRAWINGS

In the drawings, similar reference signs generally refer to the same parts throughout the different views. The drawings are not necessarily to scale, wherein emphasis is instead generally placed on representing the principles of the invention. In the following description, various aspects are described with reference to the following drawings.

FIG. 1 shows a computer for developing and/or testing software applications.

FIG. 2 illustrates a data flow for the learning of a state machine by a host system for a target system.

FIG. 3 shows a flowchart illustrating a method for learning a state machine for a program executed on an embedded system according to one embodiment.

### DETAILED DESCRIPTION

The following detailed description relates to the accompanying drawings, which, for clarification, show specific details and aspects of this disclosure in which the invention may be implemented. Other aspects may be used, and structural, logical and electrical changes may be performed without departing from the scope of protection of the invention. The various aspects of this disclosure are not necessarily mutually exclusive since some aspects of this disclosure may be combined with one or a plurality of other aspects of this disclosure to form new aspects.

Different examples will be described in more detail in the following.

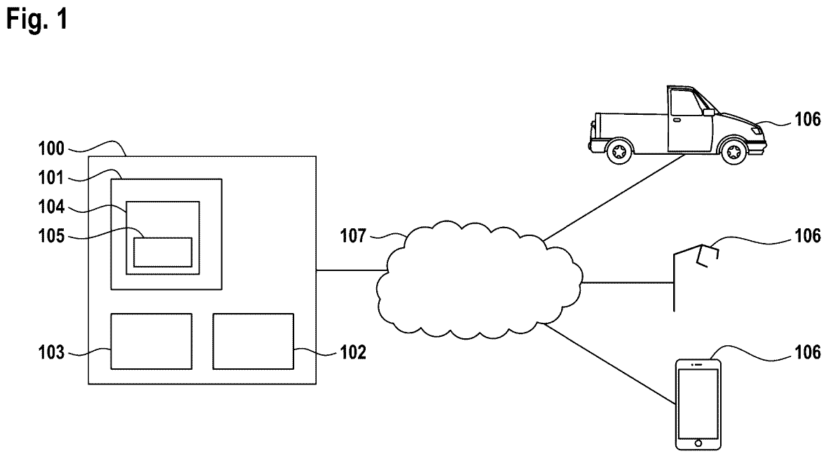

FIG. 1 shows a computer 100 for developing and/or testing software applications.

The computer 100 comprises a CPU (central processing unit) 101 and a working memory (RAM) 102. The working memory 102 is used to load program code, e.g. from a hard drive 103, and the CPU 101 executes the program code.

This example assumes that a user intends to use the computer 100 to develop and/or test a software application.

To do so, the user executes a software development environment 104 on the CPU 101.

The software development environment 104 enables the user to develop and test an application 105 for different devices 106, i.e. target hardware, such as embedded systems for controlling robot devices, including robot arms and autonomous vehicles, or also for mobile (communication) devices. For this purpose the CPU 101 can execute an emulator as part of the software development environment 104 to simulate the behavior of the respective device 106 for which an application is being or has been developed. If it is used only to test software from another source, the software development environment 104 can also be considered or configured as a software test environment.

The user can distribute the finished application to corresponding devices 106 via a communication network 107. Instead of a communication network 107, this can also be done in other ways, for example using a USB stick.

Before this happens, however, the user should test the application 105 in order to avoid distributing an improperly functioning application to the devices 106.

However, it is difficult to perform a test (e.g., a dynamic analysis) of a program for an embedded system (such as an ARM-based embedded system as an example of one of the devices 106) on a host (computer) system (in particular, a “test computer system” such as the computer 100 here). As a rule, the source code of the program cannot be compiled for other platforms (such as computer 100 in this case), and emulating the embedded system (on computer 100) requires a great deal of effort. Furthermore, the source code may not be available, e.g., if precompiled shared object files are used.

Therefore, according to various embodiments, the program is tested using a debugger (controlled by a testing system, or host system, here computer 100) on the target hardware (i.e., target system, here e.g. an embedded system 106) and the (unchanged) program (i.e. without instrumentation) is tested with it in the intended environment (i.e. on the target hardware).

The testing system 100 can use debugger hardware breakpoints to obtain partial code coverage feedback, which enables coverage-driven fuzzing. However, such testing does not readily enable state-dependent testing, i.e., testing of state-dependent behavior (or at least not reliable state-dependent testing).

However, certain errors can only be found (reliably) through state-dependent testing. An example of this is a “deep state backdoor,” which can only be triggered (and thus found) when testing state-dependent behavior: An example of such a deep state backdoor is one that is triggered by a user repeatedly sending init messages (e.g., twelve times in a row) to the target system, causing the target system to accept the user as authenticated after the twelfth init message is sent without providing valid login credentials. This means that in this case, the target system behaves according to a state machine that transitions to a different state the first eleven times the init message is received than it does on the twelfth time. This means that its response to the init message is state-dependent and the error (namely accepting the user) is therefore also state-dependent (since it only occurs in the state that the target system has reached when it has already received the init message eleven times).

To detect state-dependent errors, it is therefore necessary to take into account a changing state of the target system between or as a result of the tests performed (test iteration or “test cases”). Replacing a fuzzer with a state-dependent fuzzer is not practical or feasible: Fuzzing is a complex, search-based problem, and state-dependent fuzzing would add another dimension to the search.

However, a fuzzer can effectively find state-dependent errors if it is provided with a state machine of the target system or if a state machine of the target system is learned during fuzzing.

According to various embodiments, an approach is therefore provided that enables the estimation of state machines of a target system (in particular an embedded system) so that state-dependent errors and state-dependent back doors can be detected by means of fuzzing (in particular with debugger-controlled fuzzing). According to various embodiments, this provides an efficient, debugger-controlled way to learn state machines of a device to be tested (or even a system to be tested consisting of several devices). A fine-grained state machine can be learned, which is not possible in an embedded black box environment.

Learning finite state machines (or “state machines”) usually requires that the state machine of a program or software is unknown, but can be learned by observing the resulting output with well-formulated inputs. The learning algorithms used for this typically employ an alphabet, i.e., a set of inputs that can cause state transitions in the state machine to be learned. During the learning phase, the learning algorithms typically select an input from the alphabet more or less at random to stimulate the target system.

The learning of finite state machines is typically divided into two dimensions: activity and visibility. In terms of activity, there are active and passive learning algorithms. Whereas passive algorithms learn only from observing the data traffic, e.g. from the recorded data traffic between a client and a server, active algorithms can make new queries, for example to the server, to discover even more states. To ensure visibility, learning algorithms work in either a black box, gray box, or white box setting. In the white box environment, everything within the software and code is visible to the algorithms. In the black box setting, only the messages to the learning target can be created and the responses of the learning target can be observed without knowing the internals of the software. In the gray-box environment, light weight instrumentation has typically been compiled into the learning target to obtain some additional coverage information during runtime and to facilitate state estimation.

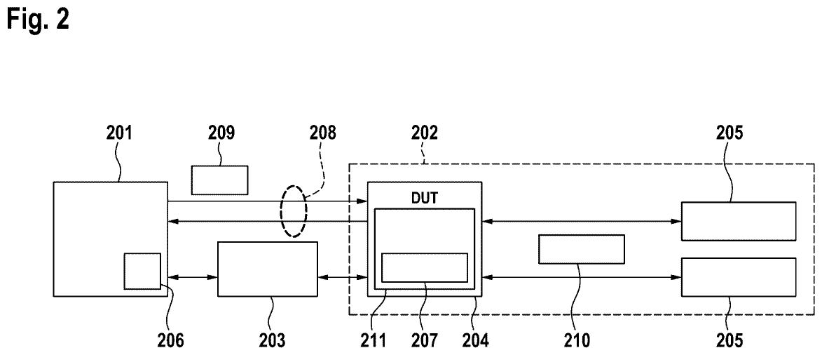

FIG. 2 illustrates a data flow for learning a state machine by a host system 201 for a program 207 on a target system 202. In this example, the target system contains a DUT (device under test, i.e. device under test) 204 and one or more data sources 205, such as sensors or other input/output devices that exchange data with the DUT 204 (e.g., supply data to the DUT 204 and are controlled by it). The DUT 204 is the program-executing unit, for example a microcontroller of the target system, e.g. an embedded system, which corresponds to one of the target devices 106, for example, and which executes the program 207 to be tested.

It should be noted that learning a state machine for a program is described below in connection with testing the program. However, the state machine can also be learned independently.

The host system 201 sends debugging commands via a debugger interface 203 to the DUT 204 of the target system 202, which is executing a target program, and receives debugging responses from it using the debugger interface 203. This means that a debugging connection exists from the host system 201 to the DUT 204, i.e., the host system 201 executes a debugger 206. The DUT 204 supports corresponding debugging (i.e., supports breakpoints, watchpoints, step-by-step execution, etc.). According to various embodiments, the program 207 to be tested contains debugging symbols (i.e. debugging information such as a symbol table, which contains and manages information about functions and global variables that are defined or referenced in the program, i.e., an assignment between symbolic names and machine addresses), which can be read and evaluated in particular by the debugger 206.

In addition, the host system 201 can supply input data (i.e., host-controlled inputs 209—as opposed to the “external”-controlled input data 210 supplied by the data sources 205) to the DUT 204. The host system 201 can also receive outputs from the DUT 204.

The host system (e.g., host computer) thus controls an input data interface 208 (between the host and the embedded system) and controls the debugger 206. The debugger 206 can reset the DUT 204, pause and resume it (i.e., program execution), and read and write its memory and registers.

According to various embodiments, the host system 201 executes fuzzing and a state machine learning algorithm in parallel.

During fuzzing, the host system 201 can generate a control flow graph of basic code blocks of the program 207 to be tested, which indicates the coverage by the test cases generated during fuzzing (fuzzing iterations).

To do this, the host system 201 sets breakpoints in various functions of the program 207 to be tested. Depending on whether and in what order the breakpoints are reached, the host system 201 can thus determine the control flow of the program 207 to be tested in the course of fuzzing (i.e., in the course of a plurality of fuzzing iterations).

As mentioned above, the host system 201 executes a learning algorithm parallel to fuzzing to learn a state machine for the program 207 to be tested, for example, the L* algorithm, the KV algorithm, the RPNI algorithm, the L*ONFSM algorithm, the L'MDP algorithm, the L'SMM algorithm, the ALERGIA algorithm, or the KVVPA algorithm. The learning algorithm feeds inputs from a so-called alphabet to the program 207 to be tested and associates them with state transitions of the state machine learned for the program 207 to be tested.

However, one difficulty arises from the fact that state transitions of the program 207 to be tested can also be caused by externally controlled inputs 210, i.e., inputs from the data sources 205, and these are not known to the host system 201.

Therefore, according to various embodiments, the host system 201 monitors the DUT 204 for the externally controlled inputs 210: If, during the learning of the state machine or during fuzzing, a new code block (e.g., a new function) is reached in the program 207 to be tested (which can be detected by triggering a breakpoint set there or by reading a coverage bitmap generated by instrumentation), the host system 201 uses the debugger 206 to determine whether and, if so, which externally controlled input 210 preceded the reaching of the new code block (i.e., a branch that has not yet occurred).

This can be done by setting watchpoints on memory areas of memory 211 of the DUT 204 to which externally controlled inputs 210 are written (e.g., a corresponding input interface is mapped):
the memory area into which the (externally controlled) input 210 is read (e.g., into which a subroutine, e.g., triggered by an interrupt from a data source 205, writes) can be known in advance.
the host system 201 can use debug symbols to determine the memory area in memory 211 to which externally controlled inputs 210 (e.g., depending on data source 205) are written.
if the host system 201 can observe externally controlled inputs 210, such as sensor values with an oscilloscope, then the host system 201 can repeat the respective iteration (fuzzing iteration or state machine learning iteration) with the same host-controlled input 209 (but with different watchpoints set in the memory 211 of the DUT 204) until the location is found to which the observed externally controlled input 210 was written.
if the host system 201 can observe externally controlled inputs 210, such as sensor values with an oscilloscope, then the host system 201 can repeatedly set watchpoints on input memory addresses of a condition that uses all or part of the externally controlled inputs 210. For example, the debugger 206 can observe a specific input value in a conditional jump instruction. Such a jump instruction normally depends on a byte or a word. A single value can be matched with an input by taint analysis.

A newly found branch in the program 207 to be tested can also be mapped (i.e., assigned) to the corresponding input source or memory area of the DUT 204 where a corresponding externally controlled input 210 is stored by means of concursive or symbolic reasoning.

By determining the memory areas of the memory 211 of the DUT 204 to which the externally controlled inputs 210 are written, the host system 201 can determine the externally controlled inputs 210 (and, if applicable, their structure) and determine which state transition the various externally controlled inputs 210 cause.

If the host system 201 finds such an input (in particular including an externally controlled input 210) that is responsible for a newly discovered branch (i.e., a branch in the program 207 to be tested that has not yet been reached) or for reaching a code block that has not yet been reached (e.g., the base block of the program 207 to be tested), then the host system 201 adds this input to the alphabet of the state machine learning algorithm, wherein the two different types of inputs are distinguished:
Host-controlled inputs 209 come from the host system 201. If such an input is responsible for a newly discovered branch or base block, it is added to the set of the host-controlled alphabet of the state machine learning algorithm, from which the host system 201 can select inputs during the execution of the state machine learning algorithm and feed them to the DUT 204 via the input interface 204 in order to learn the state machine of the program 207 to be tested.
Externally controlled inputs 210 from the data sources 205 do not originate from the host system 201 but are caused, for example, by an interrupt or a message from a data source 205. If such an input is responsible for a newly discovered branch or base block, it is added to an externally controlled alphabet. The host system 201 can observe inputs from this alphabet (by reading (e.g., using the debugger 206) the memory areas determined for this purpose from the DUT 204) in order to learn a state machine (or several) that is normally hidden for black box learning. However, the host system 201 can also inject inputs added to the externally controlled alphabet into the DUT 204: For example, it injects an interrupt using the debugger 206, which stops the DUT 204 at a specific point in time and changes the device internals (e.g., memory areas to which externally controlled inputs 210 are written, describes them accordingly) in order to determine how the DUT 204 reacts to this. Using the debugger 206, the host computer can also feed other system messages into the DUT 204 that it cannot send via the input interface 208, for example by stopping the DUT 205 at a specific point in time using a corresponding debug command and filling a memory area of the DUT 204 (e.g., a read buffer for an interface to a data source 205) and jumping to a subroutine that processes the input fed in this way from the externally controlled alphabet.

The host system 201 can thus feed inputs for the DUT 204 to the DUT 204, which contain inputs from both the host-controlled alphabet and the externally controlled alphabet. This means that for one iteration of the learning algorithm, the host system 201 feeds an input sequence from the host-controlled alphabet and the externally controlled alphabet in order to investigate the behavior of the program 207 to be tested. The host system 201 can also use inputs from these two alphabets for fuzzing iterations (for example, by building a corpus for fuzzing analogous to the two alphabets). The host system 201 can thus systematically explore the state space of the DUT 204 (in particular of the program 207).

The learning of the state machine ends when the learning algorithm aborts, i.e., it no longer finds any input that causes a state transition other than those already registered (in the learned state machine), or when learning is terminated manually (or by reaching a maximum number of iterations). The learned state machine (or several learned state machines, e.g., for several components of a system to be tested) can be output and/or used for further fuzzing iterations by the host system 201.

Since the number of breakpoints and watchpoints may be limited, it may not be possible to monitor all memory areas (i.e., input buffers for data sources 205). If this is the case, the buffers to be monitored are either selected at random or the buffers are monitored sequentially in multiple runs of the program 207 target program to be tested.

The host system 201 can also pause the DUT 204 during an input function (or a corresponding interrupt routine) and compare a current memory snapshot with an earlier memory snapshot. This can be repeated several times to find changes in memory areas that indicate input variables and state variables. In this way, the host system 201 can detect communication between the DUT 204 and the data sources 204 via shared memory. The host system 201 can use location-dependent hashes for efficient implementation to find differences in a (e.g., heap) memory of the DUT 204. According to one embodiment, the hash calculation is performed by the DUT 204 so that communication between the debugger 206 and the DUT 204 does not constitute a bottleneck. Lightweight hashes can be used for this purpose.

The host system 201 can also repeat test runs (i.e., iterations with the same input sequence) starting from a specific memory state of the DUT 204 (as determined by a memory state) in order to search for deterministic changes in the memory of the DUT 204 (wherein the host system 201 can read out the memory contents after each input of the input sequence (e.g., message) has been completed.

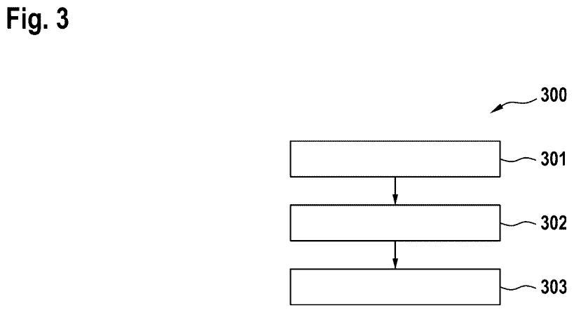

In summary, a method is provided according to various embodiments, as shown in FIG. 3.

FIG. 3 shows a flowchart 300 illustrating a method for learning a state machine for a program executed on an embedded system according to one embodiment.

A state machine learning algorithm (which uses an alphabet and assigns inputs from the alphabet to state transitions of the program that it observes) is executed by means of a host computer system connected to the embedded system via a debugging interface and an input data interface.

The host computer system controls the embedded system via the debugging interface using a debugger in such a way that it executes the program several times, wherein the host computer system
detects 301 for each execution of the program whether, during the execution of the program, a program section (of the program) has been reached which has not yet been reached during previous executions of the program; and
if it detects that a program section has been reached which has not yet been reached in the previous executions of the program, at least for some of the cases in which a program section has been reached which has not yet been reached in the previous executions of the program,
   in 302, determines an input to the program which has not been supplied to the program by the host computer system and which caused the program to reach the program section, by using the debugger to determine a memory area of a memory of the embedded system into which the input was written and reading it out; and
   in 303, adds the determined input to an alphabet of the state machine learning algorithm (i.e. at least used to associate state transitions caused by such an input with this input).

The method of FIG. 3 can be performed by one or more computers comprising one or more data processing units. The term “data processing unit” may be understood to mean any type of entity that enables the processing of data or signals. The data or signals may, for example, be processed according to at least one (i.e., one or more than one) specific function performed by the data processing unit. A data processing unit may comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail here may also be understood as a data processing unit or logic circuit array. One or more of the method steps described in detail here can be performed (e.g., implemented) by a data processing unit by means of one or more specific functions executed by the data processing unit.

According to various embodiments, the method is thus, in particular, computer-implemented.

1. A method for learning a state machine for a program (207) executed on an embedded system (202), the method comprising:
executing, by means of a host computer system (201) connected to the embedded system (202) via a debugging interface (203) and via an input data interface (208), a state machine learning algorithm, wherein the host computer system (201) controls the embedded system (202) via the debugging interface (203) by means of a debugger (206) such that it executes the program (207) several times and, wherein the host computer system (201)
detects (301) for each execution of the program (207) whether, during the execution of the program (207), a program section has been reached which has not yet been reached during previous executions of the program (207); and
when it detects that a program section has been reached which has not yet been reached during previous executions of the program (207), at least for some of the cases in which a program section has been reached which has not yet been reached in the previous executions of the program (207), an input (210) to the program (207) which was not supplied to the program (207) by the host computer system (201) and which caused the program (207) to reach the program section is determined (302), by using the debugger (206) to determine a memory area of a memory (211) of the embedded system (202) into which the input (210) was written, and reading it out; and adding the determined input (210) to an alphabet of the state machine learning algorithm (303).

2. The method according to claim 1, wherein the host computer system (201) supplies the input (210) which was not supplied by the host computer system (201) to the program (207) and which it has determined, to the program (207) by using the debugger (206) in at least some executions of the program (207).

3. The method according to claim 2, wherein the host computer system (201) writes the input (210) into the respective determined memory area of the memory (211) of the embedded system (202) by using the debugger (206) in at least some executions of the program (207).

4. The method according to claim 1, wherein the host computer system (201) determines the memory area of the memory (211) of the embedded system (202) in which the input (210) was written by setting watchpoints on different memory areas of the memory (211) of the embedded system (202) and, depending on which watchpoint is triggered, identifying the memory area to which the triggered watchpoint was set as the memory area in which the input (210) was written.

5. The method according to claim 4, wherein the host computer system (201) determines the memory area of the memory (211) of the embedded system (202) in which the input (210) was written by observing a connection between a data source that supplies the input (210) and comparing it with memory contents of the memory areas of the memory (211) to which the watchpoints were set and which were triggered.

6. The method for testing a program (207) on an embedded system (202), comprising:
learning a state machine of the program (207) according to claim 1; and
testing the program (207) during execution on the embedded system (202) taking into account the learned state machine.

7. A computer system (100) configured to perform a method according to claim 1.

8. A non-transitory, computer-readable medium that stores commands that, when executed by a computer connected to an embedded system (20), cause the computer to
execute, via a debugging interface (203) and via an input data interface (208), a state machine learning algorithm, wherein the computer controls the embedded system (202) via the debugging interface (203) by means of a debugger (206) such that it executes a program (207) several times and, wherein the computer
detects (301) for each execution of the program (207) whether, during the execution of the program (207), a program section has been reached which has not yet been reached during previous executions of the program (207); and
when it detects that a program section has been reached which has not yet been reached during previous executions of the program (207), at least for some of the cases in which a program section has been reached which has not yet been reached in the previous executions of the program (207), an input (210) to the program (207) which was not supplied to the program (207) by the computer and which caused the program (207) to reach the program section is determined (302), by using the debugger (206) to determine a memory area of a memory (211) of the embedded system (202) into which the input (210) was written, and reading it out; and adding the determined input (210) to an alphabet of the state machine learning algorithm (303).
